(19) United States
(12) Patent Application Publication
(10) Pub. No.: US 2007/0249204 A1
(43) Pub. Date: Oct. 25, 2007

(54) Electrical connector and system

(76) Inventors: Richard Petersen, Belleville, MI (US); Bhupinder Rangi, Windsor (CA)

Correspondence Address: BLANK ROME LLP, 600 NEW HAMPSHIRE AVENUE, N.W., WASHINGTON, DC, 20037, US

(21) Appl. No.: 11/405,504

(22) Filed: Apr. 18, 2006

(51) Int. Cl. H01R 4/60

(52) U.S. Cl. 439/208

(57) ABSTRACT

An electrical connector that includes a main body, and at least a first unitary one-piece contact supported by the main body. The contact includes a main portion, a first wire receiving member extending from the main portion defining a first slot configured to receive a first wire along a first axis, and a second wire receiving member extending from the main portion defining a second slot configured to receive a second wire along a second axis. And the first axis is substantially perpendicular to the second axis.

### FIELD OF THE INVENTION

The present invention relates to an electrical connector and system that may be used in various applications, such as for blasting operations. More specifically, the system includes substantially identical connectors connected in series each with identical contacts.

### BACKGROUND OF THE INVENTION

Connectors used in blasting operations typically connect a blaster with a detonator usually disposed in a hole. Conventional connectors of this type are often difficult to handle in the field because they are too small, not ergonomically shaped, and may require tools for assembly. Also, the electrical connection between the blaster and detonator is often compriomised by a faulty contact system within the connector. Additionally, the conventional connectors used in blasting operations are often easily damaged in the field.

### SUMMARY OF THE INVENTION

Accordingly, the present invention provides an electrical connector that includes a main body, and at least a first unitary one-piece contact supported by the main body. The contact includes a main portion, a first wire receiving member extending from the main portion defining a first slot configured to receive a first wire along a first axis, and a second wire receiving member extending from the main portion defining a second slot configured to receive a second wire along a second axis. And the first axis is substantially perpendicular to the second axis.

The present invention also provides an electrical connector with a main body including first and second wire receiving channels configured to receive first and second wires, and the first and second wire receiving channels being substantially perpendicular to one another. A first contact has a main portion and first and second wire receiving members extending from the main portion, and the first wire receiving member being located in the first wire receiving channel and configured to receive the first wire. A second wire receiving member being located in the second wire receiving channel and configured to receive the second wire.

The present invention also provides an electrical connector system including first and second substantially identical electrical connectors electrically connected in series by at least a first wire. A first component that is separate from the first and second electrical connectors is electrically connected in series with the first and second electrical connectors by at least the first wire. A second component separate from the first component is electrically connected to the first electrical connector by at least a second wire. A third component separate from the second component is electrically connected to the second electrical connector by at least a third wire. A first contact is disposed in the first electrical connector and coupled to the first and second wires. A second contact is disposed in the second electrical connector and coupled to the first and third wires, whereby the first component communicates with the second and third components through the first and second electrical connectors.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of an electrical connector according to an embodiment of the present invention, showing the electrical connector connected in series with substantially identical connectors to form a system;

FIG. 2 is a perspective view of the electrical connector illustrated in FIG. 1, showing a cover in the open position and the interior of the electrical connector;

FIG. 3 is a perspective view of the electrical connector illustrated in FIG. 1, showing the cover in the open position and the exterior of the electrical connector;

FIG. 4 is a partial plan view of the electrical connector illustrated in FIG. 2, showing the interior of a main body of the electrical connector;

FIG. 5 is a perspective view of a contact used with the electrical connector illustrated in FIG. 1; and

FIG. 6 is a partial perspective view in section of the electrical connector illustrated in FIG. 1, showing a contact and wire received in the electrical connector.

### DETAILED DESCRIPTION OF THE INVENTION

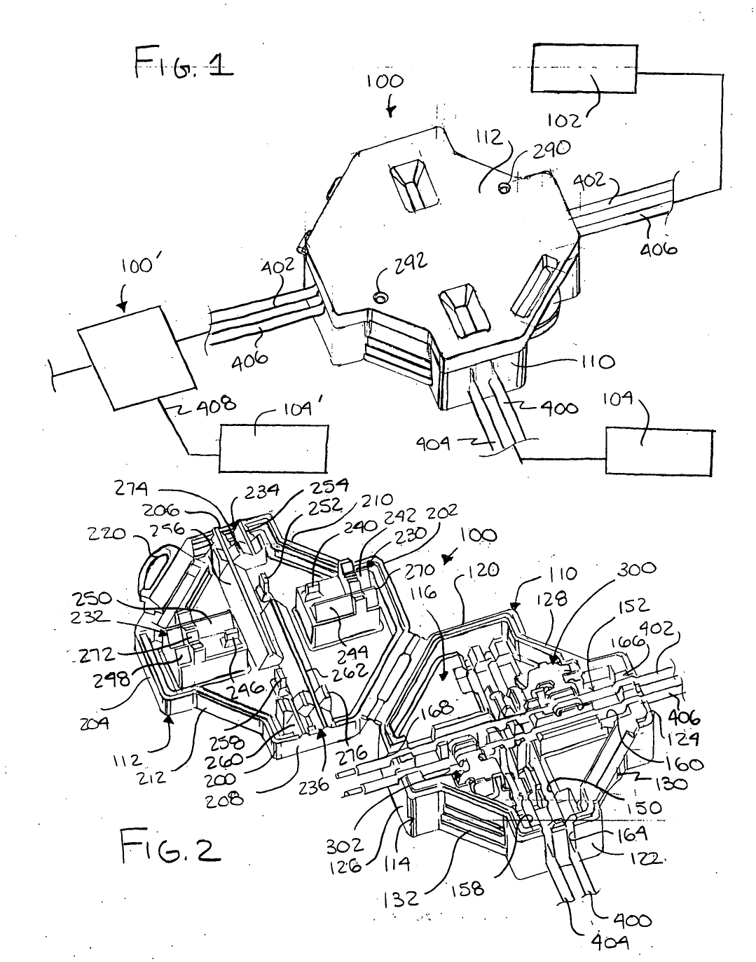

Referring to FIGS. 1-6, an electrical connector 100 and system according to the present invention electrically connects in series a plurality of substantially identical connectors (FIG. 1) to a first component 102 and a plurality of second components 104 allowing communication between the components. First component 102 may be, for example, a data device, such as a programmable logger, and/or a blaster, that communicates with the second component 104, which may be an action device, such as a detonator. For example, the logger may communicate with each detonator, such as data regarding detonator identification, timing sequence, etc., through a plurality of the electrical connectors 100, and a blaster may actually detonate the detonators. To simplify manufacturing and reduce costs, the connector 100 is designed to support at least one contact 300 that electrically connects to the other connectors and to both the first and second components 102 and 104 allowing communication therebetween. The connector 100 may also be configured to support a second contact 302 substantially identical to the first contact 300 to provide additional terminals to the other connectors and the first and second components.

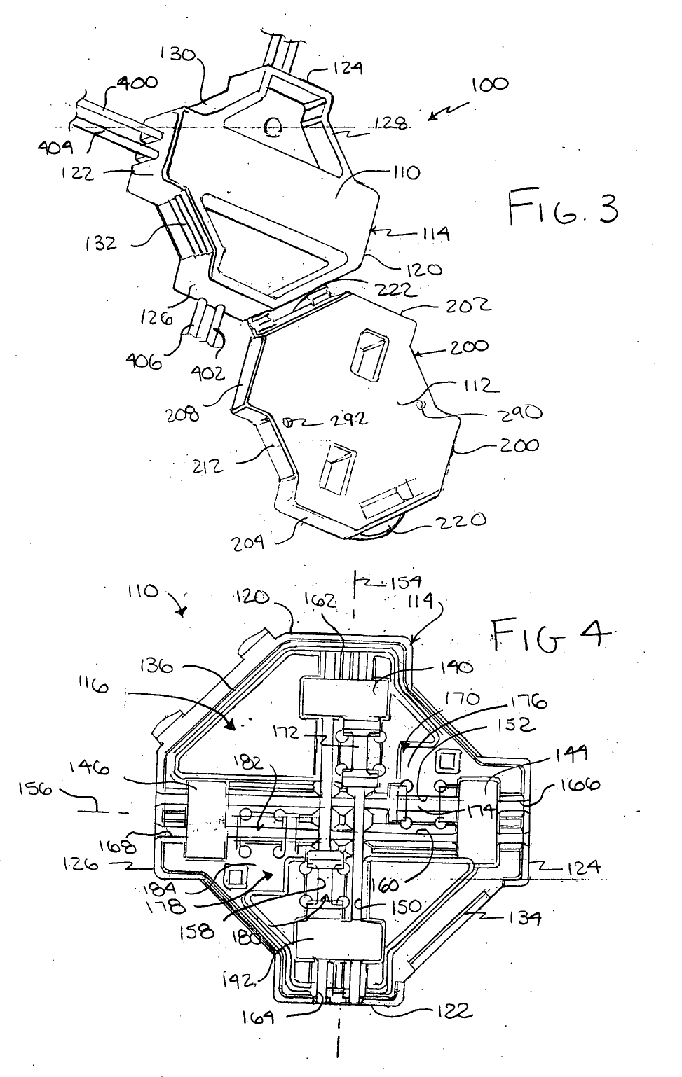

As seen in FIGS. 2 and 3, the connector 100 includes a main body 110 that supports the contacts 300 and 302 and includes a hinged cover 112. The main body 110 and hinged cover 112 are preferably formed as a unitary one-piece member, but may be formed separately and integrally attached. An outer wall 114 of the main body 110 defines a perimeter of an inner recessed area 116. Outer wall 114 includes first, second, third and fourth wall portions 120, 122, 124, and 126 with gripping sections 128, 130, and 132 between the first and third walls portions 120 and 124, the second and third wall portions 122 and 124, and the second and fourth walls portions 122 and 126, respectively, to provide an ergonomically shaped connector. The gripping section 130 between the second and third wall portions 122 and 124 also includes a latching lip 134. A pivot area 136 is disposed between the first and fourth walls portions 120 and 126 that interfaces with the hinged cover 112.

As best seen in FIGS. 2 and 4, the inner recessed area 116 includes first, second, third and fourth socket areas 140, 142, 144, and 146 corresponding to the first, second, third and fourth wall portions 120, 122, 124, and 126. At least a first wire receiving channel 150 connects the first and second socket areas 120 and 122 along a first axis 154, and at least a second wire receiving channel 152 connects the third and fourth socket areas 124 and 126 along a second axis 156. The first and second axes 154 and 156 may be substantially perpendicular such that first and second wire receiving channels 150 and 152 cross one another to facilitate connection of more than one connector 100 in series. A third wire receiving channel 158 may be disposed adjacent to and generally parallel with the first wire receiving channel 150. Likewise, a fourth wire receiving channel 160 may be disposed adjacent to and generally parallel with the second wire receiving channel 152. The latching lip 134 is preferably located between the socket areas, such as between second and third socket areas 142 and 144, to avoid interference with the wire receiving channels 150, 152, 158 and 160 and the wires disposed therein.

Each of the first and third wire receiving channels 150 and 158 terminate at one end 162 at first wall portion 120 and align with cutouts 164 in the second wall portion 122 at the opposite end. Each of the second and fourth wire receiving channels 152 and 160 align with cutouts 166 in the third wall portion 124 at one end and align with cutouts 168 in the fourth wall portion 126 at the opposite end.

The inner receiving area 116 further includes at least a first contact receiving area 170, as best seen in FIG. 4, for supporting the first contact 300. The first contact receiving area 170 may be generally located between the first and third socket areas 140 and 144 and includes first and second cavities 172 and 174 with a platform 176 therebetween. The first cavity 172 overlaps with the first wire receiving channel 150, and the second cavity 174 overlaps with the second wire receiving channel 152. A second contact receiving area 178 may be provided between the second and fourth socket areas 142 and 146 to support the second contact 302. Like the first cavity 172, the second contact receiving area 178 includes first and second cavities 180 and 182 with a platform 184 therebetween. The first cavity 180 overlaps the third wire receiving channel 158, and the second cavity 182 overlaps the fourth wire receiving channel 160.

As seen in FIG. 2, cover 112 includes an outer wall 200 with first, second, third, and fourth wall portions 202, 204, 206 and 208 corresponding to wall portions 120, 122, 124 and 126 of the main body outer wall 114. Recessed sections 210 and 212 between first and third wall portions 202 and 206, and second and fourth wall portions 204 and 208, respectively, correspond to gripping sections 128 and 132 of the main body 110. Disposed between the second and third wall portions 204 and 206 is a latch 220 that engages latching lip 134 when the cover 112 is closed on main body 110. Between first and fourth wall portions 202 and 208 is a pivot area 222 corresponding to pivot area 136 of the main body 110. A living hinge 224 is disposed between the pivot areas 136 and 222 of the main body 110 and cover 112, allowing the cover 112 to move between an open position, as seen in FIGS. 2 and 3, and a closed position, as seen in FIG. 1. The outer wall 200 defines a perimeter around first, second, third and fourth plug areas 230, 232, 234, and 236 that correspond to first, second, third and fourth socket areas 140, 142, 144, and 146, respectively, of the main body 110.

Each plug area 230, 232, 234 and 236 may include a stabilizer, a first short rib, and a second long rib to maintain first, second, third, and fourth wires 400, 402, 404, 406 in their respective wire receiving channels 150, 152, 158 and 160 of the main body 110. For example, the first plug area 230 includes a stabilizer 240 that is receivable in the first wire receiving channel 150 of the main body 110 to maintain the engagement of the first wire 400 and the first contact 300 disposed in the channel 150. The first plug area 230 also includes a first short rib 242 receivable in the first wire receiving channel 150 at terminal end 162 to maintain the wire 400 in the channel 150. A second longer rib 244 may be provided with the first plug area 230 that is receivable in the third wire channel 158 at the first socket area 140 to maintain the third wire 404 in the channel 158. Second plug area 232 is substantially similar to first plug area 230 and includes a stabilizer 246 that is receivable in the third wire receiving channel 158 to maintain engagement of the third wire 404 with the second contact 302 disposed in the channel 158. The second plug area 232 also includes a first short rib 248 receivable in the channel 158 at second socket area 142 to maintain the third wire 404 in the channel 158. A second longer rib 250 may be provided with the second plug area 232 that is receivable in the first wire receiving channel 150 to maintain the first wire 400 in the channel 150.

Third plug area 234 includes a stabilizer 252 that is receivable in the second wire receiving channel 152 to maintain engagement of the second wire 402 with the first contact 300 disposed in the channel 152. The third plug area 232 also includes a first short rib 254 receivable in the channel 152 at third socket area 144 to maintain the second wire 402 in the channel 152. A second longer rib 256 may be provided with the third plug area 234 that is receivable in the fourth wire receiving channel 160 to maintain the fourth wire 406 in the channel 160. Fourth plug area 236 is similar to the third plug area 234 and includes a stabilizer 258 that is receivable in the fourth wire receiving channel 160 to maintain engagement of the fourth wire 406 with the second contact 302 disposed in the channel 160. The fourth plug area 236 also includes a first short rib 260 receivable in the channel 160 at fourth socket area 146 to maintain the fourth wire 406 in the channel 160. A second longer rib 262 may be provided with the fourth plug area 236 that is receivable in the second wire receiving channel 152 to maintain the second wire 402 in the channel 152.

Plug areas 230, 232, 234 and 236 of the cover 112 may include a plurality of teeth 270, 272, 274, and 276, respectively. Teeth 270 and 272 fill in gaps of the first and third wire receiving channels 150 and 158 at the first and second socket areas 140 and 142, respectively, to help maintain the first and third wires 400 and 404 in their respective channels when the connector 100 is closed. Teeth 274 and 276 fill in gaps of the second and fourth wire receiving channels 152 and 160 at the third and fourth socket areas 144 and 146, respectively, to help maintain the second and fourth wires 402 and 406 in their respective channels.

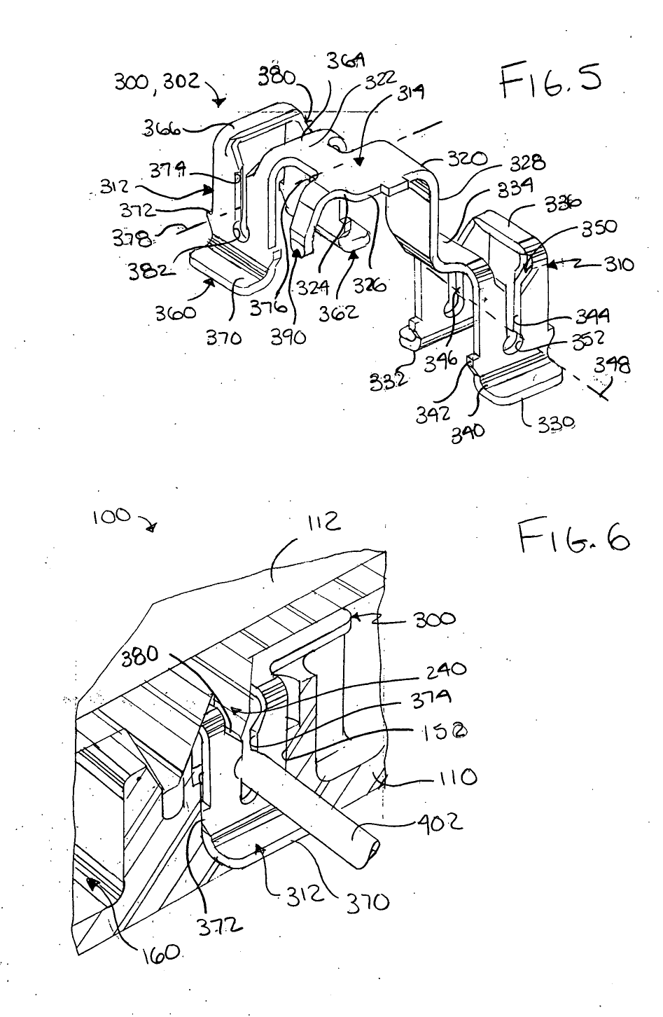

As best seen in FIG. 5, each contact 300 and 302 generally includes first and second wire receiving members 310 and 312 with a main portion 314 disposed therebetween. Each contacts 300 and 302 is preferably formed as a unitary one-piece member, but may be formed by attaching separate components. Contacts 300 and 302 are conductive and preferably made of metal, such as steel, stainless steel, copper, and the like. The first and second wire receiving members 310 and 312 generally define lower and upper portions of the contacts with respect to the main portion 314. However, it will be understood by those skilled in the art that each portion 310 or 312 may be either the upper or lower portion. The main portion 314 includes first, second, third and fourth sides 320, 322, 324 and 326. Extending from the first side 320 is a generally S-shaped extension 328 connected to the lower wire receiving portion 310, which has first and second U-shaped members 330 and 332 connected by first and second arms 334 and 336 with the first arm 334 being continuous with the S-shaped extension 328. At the base of each U-shaped member 330 and 332 is a support 340 for resting near or on the bottom of a respective wire receiving channel of the main portion 110 and at least one detent 342 for providing a frictional engagement with the respective wire receiving channel.

First and second slots 344 and 346 are defined in the first and second U-shaped members 330 and 332, respectively, that are aligned with one another to receive a wire along a first wire axis 348. Each slot 344 and 346 terminates in a substantially circular opening 352 that receives the wire. Each slot 344 and 346 preferably includes a beveled or sharp edge for insulation displacement contact with the wire, as is well known in the art. A V-shaped access opening 350 is defined between the first and second arms 334 and 336 providing access to the first and second slots 344 and 346.

Extending from the second side 322 of the main portion 314 is the upper wire receiving portion 312. Like the lower wire receiving portion 310, the upper wire receiving portion 312 includes first and second U-shaped members 360 and 362 connected by first and second arms 364 and 366 with the first arm 364 being continuous with the second side 322 of the main portion 314. At the base of each U-shaped member 360 and 362 is a support 370 for resting near or on the bottom of a respective wire receiving channel of the main portion 110 and at least one detent 372 for providing a frictional engagement with the respective wire receiving channel, as seen in FIG. 6.

First and second slots 374 and 376 are defined in the first and second U-shaped members 360 and 362, respectively, that are aligned with one another to receive a wire along a second wire axis 378. Each slot 374 and 376 terminates in a substantially circular opening 382 that receives the wire. Each slot 374 and 376 preferably includes a beveled or sharp edge for insulation displacement contact with the wire, as is well known in the art. A V-shaped access opening 380 is defined between the first and second arms 364 and 366 providing access to the first and second slots 374 and 376.

Extending from the third side 326 of the main portion 314 is a curved extension test beam 390 for testing the contacts. As seen in FIG. 1, the cover includes holes 290 and 292 that align with test beam 390 of each contact 300 and 302, allowing testing of the connector 100 and contacts when the cover 112 is closed.

First and second wire axes 348 and 378 are substantially perpendicular to one another commensurate with the orientation of the wire receiving channels 150, 152, 158 and 160 of the main body 110. Because one wire receiving portion 310 is lower than the other wire receiving portion 312 of the contacts 300 and 302, the wires received in the wire receiving channels 150, 152, 158 and 160 are allowed to overlap one another, as seen in FIG. 2.

To assemble the connector 100, the contacts 300 and 302 are installed in their respective receiving areas 170 and 178 in main body 110. In particular, the main portion 314 of the first contact 300 rests on platform 176, the lower wire receiving portion 310 of the contact 300 rests in the first wire receiving channel 150, and the upper wire receiving portion 312 rests in the second wire receiving channel 152. Similarly, the main portion 314 of the second contact 302 rests on platform 184, the lower wire receiving portion 310 of the second contact 302 rests in the third wire receiving channel 158, and the upper wire receiving portion 312 of the second contact 302 rests in the fourth wire receiving channel 160.

First, second, third, and fourth wires 400, 402, 404, and 406 are disposed in the first, second, third and fourth wire receiving channels 150, 152, 158 and 160, respectively, of the main body 110. First wire 400 is received in first and second slots 344 and 346 of the lower wire receiving portion 310 of the first contact 300, such that the edges of each slot 344 and 346 create insulation displacement contact with the wire 400, thereby electrically connecting the first contact 300 and the first wire 400. Second wire 402 is received in the first and second slots 374 and 376 of the upper wire receiving portion 312 of the first contact 300, such that the edges of each slot 374 and 376 create insulation displacement contact with the wire 402 to connect the wire 402 and first contact 300. Third and fourth wires 404 and 406 engage the lower and upper wire receiving portions 310 and 312, respectively, of the second contact 302, in the same manner as described above regarding the first and second wires 400 and 402. The curved extensions 390 of each contacts 300 and 302 are received in a respective holes 500 and 502 (FIG. 2) disposed in the main body 110.

When the cover 112 is closed, the plug areas 230, 232, 234 and 236 of the cover 112 engage the socket areas 140, 142, 144, and 146 to secured the wires. Specifically, first and second stabilizers 240 and 246 of the cover 112 are received in the V-shaped access openings 350 and 380 of the lower and upper wire receiving portions 310 and 312, respectively, of the first contact 300, as seen in FIG. 6, to maintain the first and second wires 400 and 402 in contact with the first contact 300. Likewise the third and fourth stabilizers 252 and 258 of the cover 112 are received in the V-shaped access openings 350 and 380 of the lower and upper wire receiving portions 310 and 312, respectively, of the second contact 302 to maintain the third and fourth wires 404 and 406 in contact with the second contact 302.

The design of connector 100 allows a plurality of substantially identical electrical connectors 100 to be connected in series to create a system of connectors. For example, as seen in FIG. 1, connector 100 may be connected in series to a substantially identical connector 100′ by wires 402 and 406. Any number of connectors may be connected in series by wires 402 and 406. The first component 102, such as a logger, may be connected to all of the connectors in series simply by connecting to wires 402 and 406. Connector 100′ may be coupled to another component 104′, such as a second detonator, by additional wires 408 coupled to contacts of the connector 100′ in the same manner as connector 100. Any number of detonators may communicate with a single logger or blaster through a series of connectors. Because the connectors are substantially identical, and the dual contacts 300 and 302 are substantially identical, costs are reduced and efficiency in use is increased.

While a particular embodiment has been chosen to illustrate the invention, it will be understood by those skilled in the art that various changes and modifications can be made therein without departing from the scope of the invention as defined in the appended claims.

What is claimed is:

1. An electrical connector, comprising of:
a main body; and
at least a first unitary one-piece contact supported by said main body, said contact including,
a main portion,
a first wire receiving member extending from said main portion defining a first slot configured to receive a first wire along a first axis, and
a second wire receiving member extending from said main portion defining a second slot configured to receive a second wire along a second axis,
wherein said first axis is substantially perpendicular to said second axis.

2. An electrical connector according to claim 1, further comprising
a second unitary one-piece contact substantially identical to said first contact and including first and second wire receiving members configured to receive third and fourth wires along third and fourth axes, respectively, wherein said third and fourth axes are substantially perpendicular to one another.

3. An electrical connector according to claim 1, wherein
each of said first and second slots includes an insulation displacement edge for piercing insulation of the first and second wires.

4. An electrical connector according to claim 1, wherein
said first wire receiving member includes first and second U-shaped members, said first U-shaped member defining said first slot and second U-shaped member defining another slot opposite said first slot, said first and second U-shaped members being joined to define a first generally V-shaped access opening.

5. An electrical connector according to claim 4, wherein
said second wire receiving member includes first and second U-shaped members, said first U-shaped member defining said second slot and second U-shaped member defining another slot opposite said second slot, said first and second U-shaped members being joined to define a second generally V-shaped access opening.

6. An electrical connector according to claim 5, wherein
a generally S-shaped extension extends between one of said first and second wire receiving members and said main portion.

7. An electrical connector according to claim 5, wherein
each of said U-shaped arms includes at least one securing detent extending therefrom.

8. An electrical connector according to claim 1, wherein
said first contact is formed of stainless steel.

9. An electrical connector according to claim 1, wherein
a curved extension extends from a side of said main portion of said contact for testing the contact.

10. An electrical connector, comprising of:
a main body including first and second wire receiving channels configured to receive first and second wires, said first and second wire receiving channels being substantially perpendicular to one another; and
at least a first contact having a main portion and first and second wire receiving members extending from said main portion, said first wire receiving member being located in said first wire receiving channel and configured to receive the first wire, and said second wire receiving member being located in said second wire receiving channel and configured to receive the second wire.

11. An electrical connector according to claim 10, wherein
said first contact is a unitary one-piece member.

12. An electrical connector according to claim 10, further comprising
a cover pivotally connected to said main body, said cover including at least first and second stabilizers receivable in complementary access openings in said first and second wire receiving members, respectfully, of said first contact.

13. An electrical connector according to claim 12, wherein
said cover includes at least first and second ribs spaced from said first and second stabilizers and receivable in said first and second wire receiving channels of said main body.

14. An electrical connector according to claim 13, wherein
said main body and said cover are formed as a unitary one-piece member.

15. An electrical connector according to claim 10, further comprising
third and fourth wire receiving channels disposed in said main body for receiving third and fourth wires, said third and fourth wire receiving channels being substantially perpendicular to one another; and
a second contact substantially identical to said first contact, said second contact including a main portion and first and second wire receiving members extending from said main portion, said first wire receiving member being located in said third wire receiving channel and configured to receive a third wire, and said second wire receiving member being located in said second wire receiving channel and configured to receive the second wire.

16. An electrical connector according to claim 10, wherein
said main body includes an outer wall, said outer wall including first and second cutouts continuous with said first and second wire receiving channels for allowing the first and second wires to extend therethrough.

17. An electrical connector according to claim 16, wherein
said outer wall includes a plurality of recessed gripping areas for gripping said main body.

18. An electrical connector according to claim 10, wherein
said cover includes a latch that engages a locking lip located on an outer wall of said main body.

19. An electrical connector system, comprising of:
first and second substantially identical electrical connectors electrically connected in series by at least a first wire;
a first component separate from said first and second electrical connectors and electrically connected in series with said first and second electrical connectors by at least said first wire;
a second component separate from said first component electrically connected to said first electrical connector by at least a second wire;
a third component separate from said second component electrically connected to said second electrical connector by at least a third wire,
a first contact disposed in said first electrical connector and coupled to said first and second wires; and
a second contact disposed in said second electrical connector and coupled to said first and third wires,
whereby said first component communicates with said second and third components through said first and second electrical connectors.

20. An electrical connector system according to claim 19, wherein
said second and third wires are substantially perpendicular to said first wire.

21. An electrical connector system according to claim 19, wherein
each of said first and second contacts is a unitary one-piece member.

22. An electrical connector system according to claim 18, wherein
said first component is a programmable logger; and
said second component is a detonator.
